(19) United States
(12) Patent Application Publication
(10) Pub. No.: US 2019/0383988 A1
(43) Pub. Date: Dec. 19, 2019

(54) COMPOSITE OPTICAL FILM, BACKLIGHT MODULE USING SAME, AND LIQUID CRYSTAL DISPLAY THEREOF

(71) Applicant: HUIZHOU CHINA STAR OPTOELECTRICS TECHNOLOGY CO., LTD., Huizhou Guangdong (CN)

(72) Inventor: Yong FAN, Huizhou Guangdong (CN)

(21) Appl. No.: 15/752,573

(22) PCT Filed: Jan. 17, 2018
(86) PCT No.: PCT/CN2018/073054

§ 371 Date: Nov. 16, 2018

(30) Foreign Application Priority Data
Dec. 27, 2017 (CN) 201711446561.4

(51) Int. Cl. F21V 8/00; G02F 1/1335

(52) U.S. Cl. CPC G02B 6/0053; G02F 1/133514; G02F 1/133528; G02B 6/0056

(57) ABSTRACT

Disclosed is a composite optical film, including a first sealing film and a second sealing film disposed in opposite to each other; a cholesterol LC brightness enhancement film interposed between the first and second sealing film; and a quantum dot (QD) film interposed between the cholesterol LC brightness enhancement film and the second sealing film, thereby integrating the cholesterol LC brightness enhancement film and QD film. By encapsulating the cholesterol LC brightness enhancement film and the QD film between the watertight and oxygen-tight first and second sealing film, the reliability of the cholesterol LC brightness enhancement film and the QD film on the durability against water and oxygen is enhanced. Besides, because the cholesterol LC brightness enhancement film can repeatedly emit light to excite quantum dots of the QD film for increasing the utilization of quantum dots, the concentration of quantum dots in QD film and manufacturing cost are reduced.

### RELATED APPLICATIONS

The present application is a National Phase of International Application Number PCT/CN2018/073054, filed Jan. 17, 2018, and claims the priority of China Application No. 201711446561.4, filed Dec. 27, 2017.

### FIELD OF THE DISCLOSURE

The invention relates to the field of optical film fabrication, and more particularly to a composite optical film, a backlight module using same, and a liquid crystal display thereof.

### BACKGROUND

With the evolution of electro-optics and semiconductor technology, the progress of display technology has driven the flourishing development of flat panel display. For various kinds of flat panel displays, liquid crystal display (LCD) has numerous advantageous characteristics in terms of high spatial utilization, low power consumption, null radiation, and low electromagnetic interference. Hence, liquid crystal display has become the mainstream in the display market.

Quantum dot (QD) are advantageously characterized by adjustable luminescence spectrum, narrow full-width at half maximum (FWHM), and high luminous efficiency. As a result of these advantages, quantum dots have been applied to LCD for significantly widening the color gamut of LCD. More advantageously, as quantum dots have a small size in nanometers, they are not prone to deposit and can be mixed up uniformly in adhesive. Therefore, when quantum dots are applied to display, the quantum dot display is able to realize better color uniformity and wider color gamut than a conventional LCD. The contemporary quantum dots are categorized in cadmium-containing quantum dots, e.g. cadmium selenide (CdSe) quantum dots, and cadmium-free quantum dots, e.g. Indium phosphide (InP) quantum dots, as well as perovskite quantum dots. Particularly, as the cadmium selenide (CdSe) quantum dots have advantages in terms of good stability, high luminous efficiency, narrow full-width at half maximum, and wide color gamut, they are quite advantageous in optical applications. However, as the cadmium selenide (CdSe) quantum dots contain cadmium, how to maximize the conversion efficiency of the blue light in quantum dots, increase the utilization of quantum dot material, and lower the content of cadmium have become an important challenge for display manufacturers.

Cholesterol liquid crystal (LC) brightness enhancement film employs cholesterol liquid crystals to convert natural light into circularly-polarized light, which in turn is converted into a linearly-polarized light by a quarter-wave plate. Because the polarization direction of the linearly-polarized light is conformable to the analyzation direction of the lower polarizer of the LCD panel, the absorption of light by the lower polarizer is reduced and the utilization of light is enhanced. Nonetheless, the contemporary cholesterol LC brightness enhancement film is quite sensitive to water and oxygen. Thus, the problem of low durability against water and oxygen for the cholesterol LC brightness enhancement film still needs to be solved.

Nowadays, there have been no composite optical film for integrating a cholesterol LC brightness enhancement film and a quantum dot film. Hence, it is inclined to tackle with the technical hindrance of integrating a cholesterol LC brightness enhancement film and a quantum dot film.

### SUMMARY

To address the problems existing in the prior art, an object of the invention to provide a composite optical film for integrating a cholesterol LC brightness enhancement film and a quantum dot film, and a backlight module using such composite optical film, and a liquid crystal display thereof.

According to one aspect of the invention, a composite optical film is provided, which includes: a first sealing film, a second sealing film disposed in opposite to the first sealing film, a cholesterol LC brightness enhancement film interposed between the first sealing film and the second sealing film, and a quantum dot film interposed between the cholesterol LC brightness enhancement film and the second sealing film.

Further, the composite optical film further includes: an alignment film layer interposed between the cholesterol LC brightness enhancement film and the quantum dot film.

Further, the cholesterol LC brightness enhancement film includes: a cholesterol liquid crystal layer interposed between the quantum dot film and the first sealing film, and a quarter-wave plate interposed between the cholesterol liquid crystal layer and the first sealing film.

Further, the first sealing film and the second sealing film are watertight and oxygen-tight.

According to another aspect of the invention, a backlight module is provided, which includes: a light-guiding plate having a light output surface, and a composite optical film as described above, in which the second sealing film of the composite optical film is located on the light output surface.

Further, the light-guiding plate further includes a bottom surface in opposite to the light output surface. The backlight module further includes a reflective film disposed under the bottom surface.

Further, the light-guiding plate further includes a light input surface connected between the light output surface and the bottom surface. The backlight module further includes a light source having a light output surface facing the light input surface of the backlight module.

Further, the light source is a blue-light light-emitting diode (LED).

According to another yet aspect of the invention, a liquid crystal display is provided, which includes: a backlight module as described above, a liquid crystal cell disposed in opposite to the light output surface of the backlight module, a first polarizer disposed at the side of the liquid crystal cell facing away from the light output surface of the backlight module, and a second polarizer disposed at the side of the liquid crystal cell facing the light output surface of the backlight module.

Further, the liquid crystal cell includes: a color filter substrate disposed in opposite to the light output surface of the backlight module, in which the first polarizer is disposed at the side of the color filter substrate facing away from the light output surface of the backlight module; and an array substrate interposed between the color filter substrate and the backlight module, in which the array substrate and the color filter substrate are assembled in opposite to each other in the cell, and the second polarizer is interposed between the array substrate and the light output surface of the backlight module; and a liquid crystal layer interposed between the color filter substrate and the array substrate.

The benefits of the invention: The invention fulfills the object of integrating the cholesterol LC brightness enhancement film and the quantum dot film. Besides, by encapsulating the cholesterol LC brightness enhancement film and the quantum dot film between the watertight and oxygen-tight first sealing film and the second sealing film, the reliability of the cholesterol LC brightness enhancement film and the quantum dot film on the durability against water and oxygen is enhanced. Further, because the cholesterol LC brightness enhancement film is able to repeatedly emit light to excite the quantum dots of the quantum dot film, the utilization of the quantum dots of the quantum dot film is enhanced, thereby increasing luminous efficiency and widening the viewing angle. Hence, the concentration of the quantum dot in the quantum dot film can be lowered, and thus the content of cadmium in the quantum dot film can be lowered as well. In this way, the manufacturing cost of the quantum film can be reduced.

### BRIEF DESCRIPTION OF THE DRAWINGS

The embodiments embodying the invention and other aspects, features, and advantages of the invention will be more clearly explicated by the following descriptions and accompanying drawings. In the figures:

FIG. 1 is a schematic diagram showing the structure of a composite optical film according to an embodiment of the disclosure;

FIG. 2 is a schematic diagram showing the structure of a backlight module according to an embodiment of the disclosure; and

FIG. 3 is a schematic diagram showing the structure of a liquid crystal display according to an embodiment of the disclosure.

### DETAILED DESCRIPTION OF PREFERRED EMBODIMENTS

Next, an embodiment of the invention will be given by the following detailed descriptions and the accompanying drawings. Nevertheless, the invention can be fulfilled in various forms. Also, the invention should not be construed to be limited to the concrete embodiments described herein. On the contrary, these embodiments are proposed to illustrate the principles and practical applications of the invention, in order to allow an artisan skilled in the art to understand that various exemplary embodiments and various modifications to the embodiment can be made to adapt the invention for particular applications.

In the drawings, the thickness of layers and regions are exaggerated. Same reference numeral indicates same element throughout the specification and drawings.

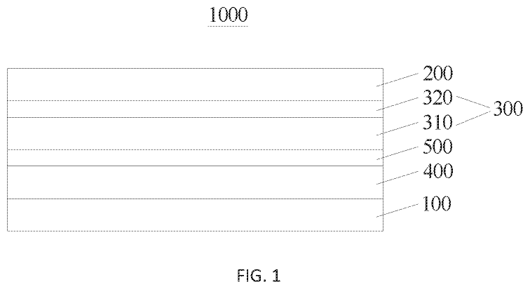

FIG. 1 shows the structure of a composite optical film according to an embodiment of the invention.

Please refer to FIG. 1. The composite optical film 1000 according to an embodiment of the invention includes: a first sealing film 100, a second sealing film 200, a cholesterol liquid crystal (LC) brightness enhancement film 300, a quantum dot film 400, and an alignment film layer 500.

Concretely speaking, the first sealing film 100 is disposed in opposite to the second sealing film 200. In this embodiment, the first sealing film 100 and the second sealing film 200 are oxygen-tight and watertight. Hence, the first sealing film 100 and the second sealing film 200 are made up of material having oxygen-tightness and water-tightness, for example, polyvinylidene chloride (PVDC), Ethylene vinyl alcohol (EVOH), Polyamide (PA), polyesters such as polyethylene terephthalate (PET) or polyethylene naphthalate (PEN), and polyimide (PI).

The cholesterol LC brightness enhancement film 300 is interposed between the first sealing film 100 and the second sealing film 200. The function of the cholesterol LC brightness enhancement film 300 will be described later. The quantum dot film 400 is interposed between the cholesterol LC brightness enhancement film 300 and the second sealing film 200. Thus, this embodiment is able to fulfill the object of integrating the cholesterol LC brightness enhancement film 300 and the quantum dot film 400.

Besides, because the cholesterol LC brightness enhancement film 300 and the quantum dot film 400 are both encapsulated between the oxygen-tight and watertight first sealing film 100 and second sealing film 200, the reliability of the cholesterol LC brightness enhancement film 300 and the quantum dot film 400 on the sensitivity to oxygen and water can be enhanced. In the meantime, because the cholesterol LC brightness enhancement film 300 can repeatedly excite the quantum dots of the quantum dot film 400, the utilization of the quantum dots of the quantum dot film 400 is enhanced. As a result, the luminous efficiency is enhanced and the viewing angle is widened. More advantageously, with the use of the invention, the concentration of the quantum dot in the quantum dot film 400 is reduced and the content of the cadmium in the quantum dot film 400 is lowered, thereby reducing the manufacturing cost of the quantum dot film 400.

Furthermore, an alignment film layer 500 is interposed between the cholesterol LC brightness enhancement film 300 and the quantum dot film 400 for connecting to the cholesterol LC brightness enhancement film 300. In this way, the cholesterol liquid crystals in the cholesterol LC brightness enhancement film 300 can be pre-aligned. Alternatively, the cholesterol liquid crystals in the cholesterol LC brightness enhancement film 300 may not need to be pre-aligned, and thus the alignment film layer 500 may be omitted.

In accordance with one embodiment of the invention, the cholesterol LC brightness enhancement film 300 includes: a cholesterol liquid crystal layer 310 interposed between the quantum dot film 400 and the first sealing film 100, and a quarter-wave plate 320 interposed between the cholesterol liquid crystal layer 310 and the first sealing film 100.

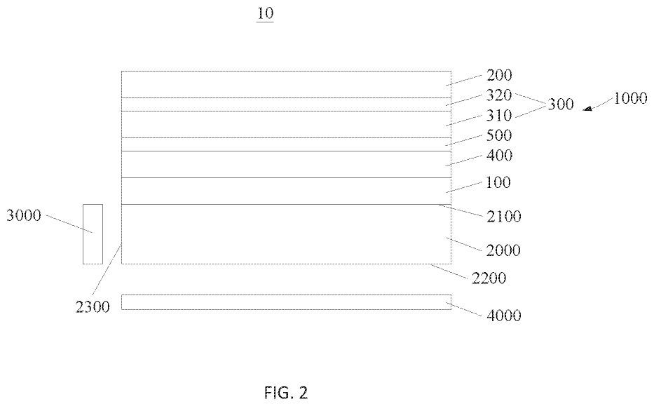

Next, the application of the composite optical film 1000 to the backlight module will be described as follows. FIG. 2 shows the structure of the backlight module according to an embodiment of the invention.

Please refer to FIG. 2, the backlight module 10 according to an embodiment of the invention includes a composite optical film 1000, a light-guiding plate 2000, a light source 3000, and a reflective film 4000. It should be understood that the backlight module 10 according to an embodiment of the invention may include other essential parts.

Concretely speaking, the light-guiding plate 2000 includes a light output surface 2100, a bottom surface 2200 disposed in opposite to and parallel with the light output surface 2100, and a light input surface 2300 connected to one side of the light output surface 2100 and the same side of the bottom surface.

The composite optical film 1000 is disposed on the light output surface 2100. Concretely speaking, the first sealing film 100, the quantum dot film 400, the alignment film layer 500, the cholesterol LC brightness enhancement film 300, and the second sealing film 200 are sequentially disposed atop the light output surface 2100. Therefore, the blue light exiting through the light output surface 2100 is provided to the LCD panel through the composite optical film 1000.

The light source 3000 is disposed adjacently to the light input surface 2300. In this embodiment, the light source 3000 may be a blue-light LED. The light emitted from the light source 3000 enters the light-guiding plate 2000 through the light input surface 2300 and exits through the light output surface 2100.

The reflective film 4000 is disposed under the bottom surface 2200. The blue light in the interior of the light-guiding plate 2000 exits through the bottom surface 2200 and hits the reflective film 4000, so that the reflective film 4000 reflects the inputted blue light back to the interior of the light-guiding plate 2000. In this way, the utilization of blue light in the interior of the light-guiding plate 2000 is enhanced. In accordance with one embodiment of the invention, the reflective film 4000 is optional.

Here, the backlight module 10 shown in the drawings is an edge backlight module. However, the type of the backlight module 10 is not limited to the precise type disclosed herein. For example, the backlight module 10 may be a direct backlight module.

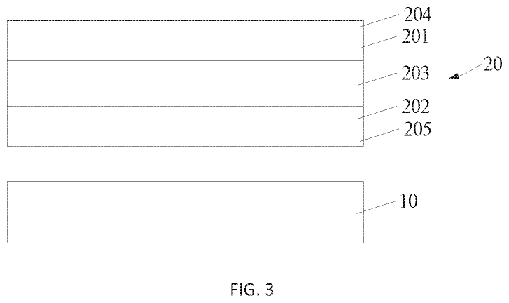

FIG. 3 shows the structure of a liquid crystal display according to an embodiment of the invention.

Please refer to FIG. 3. The liquid crystal display according to an embodiment of the invention includes: a backlight module 10 and a LCD panel 20. The light output surface 210 of the backlight module 10 (shown in FIG. 2) faces the LCD panel 20 for allowing the backlight module 10 to provide light for the LCD panel 20 for displaying images.

The LCD panel 20 includes: a color filter substrate 201 and an array substrate 202 assembled in opposite to each other in the liquid crystal cell, and a liquid crystal layer 203 interposed between the color filter substrate 201 and the array substrate 202, in which the color filter substrate 201, the array substrate 202, and the liquid crystal layer 203 constitute a liquid crystal cell. A first polarizer 204 is adhered to a first surface of the liquid crystal cell (i.e. the surface of the color filter substrate 201 facing away from the array substrate 202). A second polarizer 205 is adhered to adhered to a second surface of the liquid crystal cell (i.e. the surface of the array substrate 202 facing away from the color filter substrate 201). The backlight module 10 faces the second polarizer 205.

Please refer to FIG. 1 to FIG. 3. The cholesterol liquid crystal layer 310 converts the light exiting through the light output surface 210 into right-hand polarized light, which in turn is converted into a linearly-polarized light by the quarter-wave plate 320. The polarization direction of the linearly-polarized light is conformable to the analyzation direction of the second polarizer 205. Hence, the absorption of the light by the second polarizer 205 of the LCD panel 20 is reduced, thereby enhancing the utilization of the light.

In conclusion, the embodiment of the invention fulfills the object of integrating a cholesterol LC brightness enhancement film and a quantum dot film. Besides, because the cholesterol LC brightness enhancement film and the quantum dot film are encapsulated between the watertight and oxygen-tight first sealing film and second sealing film, the reliability of the cholesterol LC brightness enhancement film and the quantum dot film on the durability against water and oxygen is enhanced. Further, because the cholesterol LC brightness enhancement film can repeatedly excite quantum dots of the quantum dot film, the utilization of the quantum dot of the quantum dot film and the luminous efficiency is enhanced. As a result, the concentration of the quantum dot in the quantum dot film is reduced, thereby lowering the content of cadmium of the quantum dot film and reducing the manufacturing cost of the quantum dot film.

Although the invention has been described by reference to the specific embodiment disclosed herein, an artisan skilled in the art would understand that various modifications to details and forms of the embodiment can be made without departing from the spirit and principles of the invention, which is defined by the appended claims and their equivalents.

What is claimed is:

1. A composite optical film, comprising:
a first sealing film;
a second sealing film disposed in opposite to the first sealing film;
a cholesterol liquid crystal (LC) brightness enhancement film interposed between the first sealing film and the second sealing film; and
a quantum dot film interposed between the cholesterol LC brightness enhancement film and the second sealing film.

2. The composite optical film according to claim 1, further comprising an alignment film layer interposed between the cholesterol LC brightness enhancement film and the quantum dot film.

3. The composite optical film according to claim 1, wherein the cholesterol LC brightness enhancement film includes:
a cholesterol liquid crystal layer interposed between the quantum dot film and the first sealing film; and
a quarter-wave plate interposed between the cholesterol liquid crystal layer and the first sealing film.

4. The composite optical film according to claim 2, wherein the cholesterol LC brightness enhancement film includes:
a cholesterol liquid crystal layer interposed between the quantum dot film and the first sealing film; and
a quarter-wave plate interposed between the cholesterol liquid crystal layer and the first sealing film.

5. The composite optical film according to claim 1, wherein the first sealing film and the second sealing film are watertight and oxygen-tight.

6. A backlight module, comprising:
a light-guiding plate having a light output surface; and
a composite optical film, wherein the composite optical film comprises:
a first sealing film;
a second sealing film disposed in opposite to the first sealing film;
a cholesterol liquid crystal (LC) brightness enhancement film interposed between the first sealing film and the second sealing film; and
a quantum dot film interposed between the cholesterol LC brightness enhancement film and the second sealing film;
wherein the second sealing film is located on the light output surface.

7. The backlight module according to claim 6, wherein the light-guiding plate further includes a bottom surface disposed in opposite to the light output surface, and wherein the backlight module further includes a reflective film disposed under the bottom surface.

8. The backlight module according to claim 7, wherein the light-guiding plate further includes a light input surface connected between the light output surface and the bottom surface, and wherein the backlight module further includes a light source having a light output surface facing the light input surface of the light-guiding plate.

9. The backlight module according to claim 8, wherein the light source is a blue-light light-emitting diode.

10. The backlight module according to claim 6, wherein the composite optical film further includes:
an alignment film layer interposed between the cholesterol LC brightness enhancement film and the quantum dot film.

11. The backlight module according to claim 6, wherein the cholesterol LC brightness enhancement film includes:
a cholesterol liquid crystal layer interposed between the quantum dot film and the first sealing film; and
a quarter-wave plate interposed between the cholesterol liquid crystal layer and the first sealing film.

12. The backlight module according to claim 10, wherein the cholesterol LC brightness enhancement film includes:
a cholesterol liquid crystal layer interposed between the quantum dot film and the first sealing film; and
a quarter-wave plate interposed between the cholesterol liquid crystal layer and the first sealing film.

13. The backlight module according to claim 6, wherein the first sealing film and the second sealing film are watertight and oxygen-tight.

14. A liquid crystal display, comprising:
a backlight module, wherein the backlight module comprises:
a light-guiding plate having a light output surface; and
a composite optical film, wherein the composite optical film comprises:
a first sealing film;
a second sealing film disposed in opposite to the first sealing film;
a cholesterol liquid crystal (LC) brightness enhancement film interposed between the first sealing film and the second sealing film; and
a quantum dot film interposed between the cholesterol LC brightness enhancement film and the second sealing film;
wherein the second sealing film is located on the light output surface;
a liquid crystal cell disposed in opposite to the backlight module;
a first polarizer disposed at the side of the liquid crystal cell facing away from the light output surface of the backlight module; and
a second polarizer disposed at the side of the liquid crystal cell facing the light output surface of the backlight module.

15. The liquid crystal display according to claim 14, wherein the liquid crystal cell includes:
a color filter substrate disposed in opposite to the light output surface of the backlight module, wherein the first polarizer is disposed at the side of the color filter substrate facing away from the light output surface of the backlight module;
an array substrate interposed between the color filter substrate and the backlight module, wherein the array substrate and the color filter substrate are assembled in opposite to each other in the liquid crystal cell, and wherein the second polarizer is interposed between the array substrate and the light output surface of the backlight module; and
a liquid crystal layer interposed between the color filter substrate and the array substrate.
